(19) United States
(12) Patent Application Publication
(10) Pub. No.: US 2011/0319048 A1
(43) Pub. Date: Dec. 29, 2011

(54) EMERGENCY ALERT DEVICE WITH SILENT GPS AND MOBILE COMMUNICATIONS CAPABILITIES

(76) Inventor: Kenny Lofland Matlock, Marathon, FL (US)

(21) Appl. No.: 12/824,613

(22) Filed: Jun. 28, 2010

(51) Int. Cl. H04M 11/04; G08B 1/08

(52) U.S. Cl. 455/404.1; 340/539.11; 340/539.13

(57) ABSTRACT

An emergency alert device with tactile features to allow a user to discretely report an emergency without the need to look at the device is disclosed. The device may include a body with a cover. A processor, an antenna, and a battery may be located within the body. At least one button may be located under the cover for protection. The button may have a tactile feature corresponding to an emergency service, such that a user can identify the desired emergency service by touch.

### FIELD

This application relates generally to emergency alert devices, and in particular to personal emergency alert devices that can be activated discretely.

### BACKGROUND

Safety and security are primary concerns for many people. Many people are injured or killed each year due to accidents and crime. Cell phones and other emergency notification devices have proven to be very useful in helping people in distress. For example, emergency location beacons, such as a Spot-SM Emergency Beacon Locator, or similar GPS emergency location devices made by ACR Electronics, Inc., or other manufacturers have been useful in contacting emergency response entities when a person is in distress in a remote location. In many cases, the accidents or crimes causing the distress may be preventable, or at least the effects of the incidents minimized, with timely response by emergency personnel. Additionally, in some instances the simple threat of being able to summon help can prevent some criminal behavior.

However, in some instances a criminal may be looking to steal or otherwise disable a cell phone or other emergency notification device. Similarly, a criminal may be aggravated by a known attempt to contact emergency services, such as during an abduction or rape. In such instances, having and attempting to use a cell phone or audible emergency device may cause additional risk or harm to the victim. Additionally, cell phones do not function in many locations, particularly in some remote areas that are used for outdoor recreation.

Similarly, cell phones and other emergency notification devices tend to be large and bulky, making them hard to use discretely and inconvenient to carry, particularly when enjoying the outdoors or exercising.

### SUMMARY

An emergency alert device for silent communication with a selected emergency service is claimed, the emergency alert device comprising: a case having an interior space for electronic components; a cover movably coupled to the case; a battery located within the interior space; a processor located within the interior space; an antenna located within the interior space; and at least one button configured to send a signal to an emergency service, the at least one button having a tactile feature corresponding to the emergency service, the tactile feature enabling a user to identify the emergency service solely by touch.

In some embodiments, the case is sized and shaped like a watch. In some embodiments, the cover is configured to cover the at least one button so as to avoid inadvertent pressing of the at least one button. In some embodiments, the emergency service is a police emergency service. In some embodiments, the emergency service is a medical emergency service. In some embodiments, the emergency service is a fire emergency service. In some embodiments, the emergency alert device is a battery charge indicator. In some embodiments, the antenna includes a GPS antenna and/or a mobile telephone antenna.

In some embodiments, the emergency alert device further comprises a memory operatively coupled to the processor. In some of these embodiments, the memory is configured to store location data periodically acquired through the GPS antenna. In some of these embodiments, the signal of the emergency alert device includes the stored location data which the memory is configured to store. In some embodiments including a memory, the signal includes one of a plurality of pre-recorded messages stored on the memory.

An emergency alert device for silent communication with a selected emergency service is claimed, the emergency alert device comprising: a case; an antenna for communicating with an emergency response system; a button that communicates with an emergency response system when pressed; and memory having a plurality of pre-recorded messages, each message indicating a level of urgency and type of emergency, the level of urgency corresponding to the number of times the button is pressed.

In some embodiments, the button includes a tactile feature, the tactile feature corresponding to the type of emergency. In some embodiments, the antenna is a GPS antenna and/or a mobile telephone antenna. In some embodiments, the emergency alert device further comprises a cover movably coupled to the case and configured to prevent accidental pressing of the button.

In some embodiments, the emergency alert device further comprises a status indicator that indicates the level of urgency selected. In some embodiments, the location of the device is communicated to the emergency response system when the button is pressed. In some embodiments, the emergency alert device further comprises a second button, wherein each button corresponds to a different type of emergency. In some of these embodiments, an all-clear message is communicated to the emergency response system when both buttons are pressed simultaneously for at least 5 seconds.

### BRIEF DESCRIPTION OF THE DRAWINGS

The following description can be better understood in light of Figures, in which:

FIG. 1 is an illustration of an exemplary embodiment of a emergency alert device;

FIG. 2 is an illustration of the emergency alert device of FIG. 1 with the cover in a closed position;

FIG. 3 is an bottom-view illustration of the emergency alert device of FIG. 1;

FIGS. 4 and 5 are illustrations of a embodiments of emergency alert devices with alternate covers;

FIG. 6 is an illustration of an embodiment of an emergency alert device with specially shaped buttons;

FIG. 7 is an illustration of an embodiment of an emergency alert device with a wristband;

FIG. 8 is an illustration of an embodiment of an emergency alert device with sliding buttons;

FIG. 9 is an illustration of an embodiment of an emergency alert device with a touch-display; and

FIG. 10 is functional diagram of components of an exemplary emergency alert device.

Together with the following description, the Figures demonstrate and explain the principles of inventive emergency alert devices and methods for using and making the devices. In the Figures, the thickness and configuration of components may be exaggerated for clarity. The same reference numerals in different Figures represent the same component.

### DETAILED DESCRIPTION

The following description supplies specific details in order to provide a thorough understanding. Nevertheless, the skilled artisan would understand that embodiments of emergency alert devices and associated methods of using the devices can be implemented and used without employing these specific details. Indeed, exemplary embodiments and associated methods can be placed into practice by modifying the illustrated units and associated methods and can be used in conjunction with any other devices and techniques conventionally used in the industry. For example, while the description below focuses on a generally watch-sized emergency alert device, the apparatus and associated methods could be equally applied in any electronic package, such as in a cell phone, PDA, music player, personal game system, pager, etc.

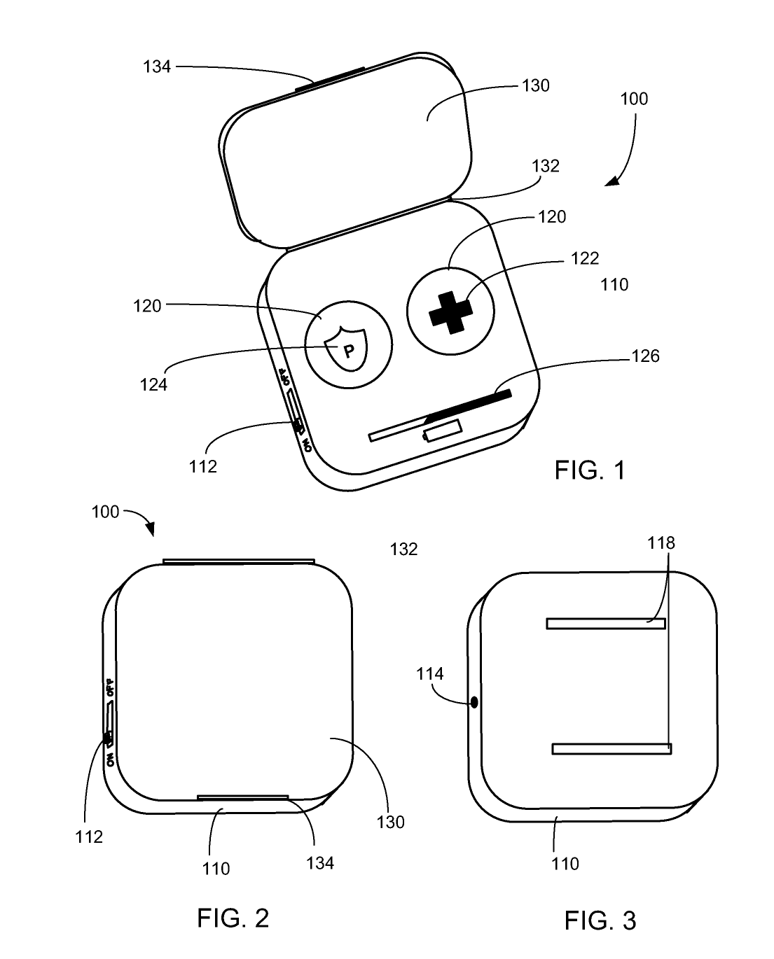

One exemplary emergency alert device is illustrated in FIGS. 1-3. In the Figures, emergency alert device 100 is shown. Emergency alert device 100 includes body 110, buttons 120, and cover 130. Body 110 can be any desired shape or size, such as wristwatch sized as illustrated, or any other desired shape and size. For example, body 110 may be a smartphone, or a personal game system, such as a Sony PSP®, cell phone, or any other device. Body 110 and cover 130 can be formed of any suitable material, such as metal, plastic, ceramic, etc, selected and formed such that body 110 can be waterproof and shock resistant for durability in activities such as running, swimming, boating, mountain biking, etc.

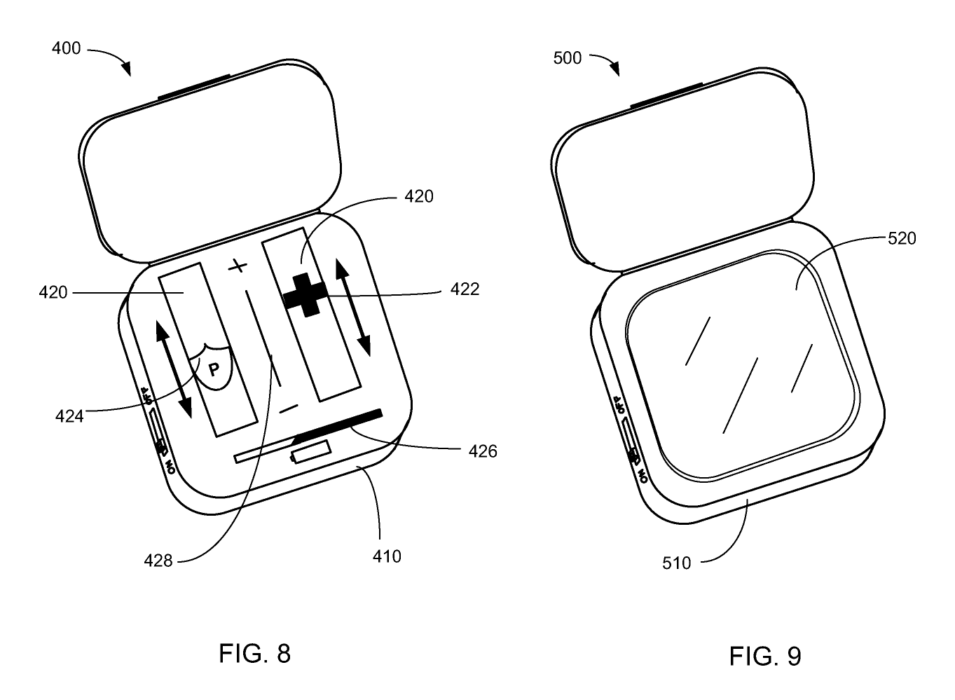

Power switch 112 can extend from body for tactile use, such that the switch can be moved and felt without looking at emergency alert device 100. Body 110 can also provide access to power port 114, and can include fastening elements 118. Fastening elements 118 can be used to attach emergency alert device 100 to a watchband, keychain, clip, wristband 190 (FIG. 7), or any other securement as desired. In some embodiments, fastening elements 118 can be an eyelet for a lanyard, or other similar securement methods.

Cover 130 can be formed to cover buttons 120 to prevent accidental alerts from unintentionally pressing buttons 120. Cover 130 can be attached to body 110 with hinge 132, and can include an edge grip 134 to facilitate opening cover 130 without looking. In some embodiments, cover 130 can include an opening so a user can see battery indicator 126 without having to open cover 130. Cover 130 can also be formed of a transparent material, such as polycarbonate, to allow a user to see buttons 120 and battery indicator 126 through cover 130.

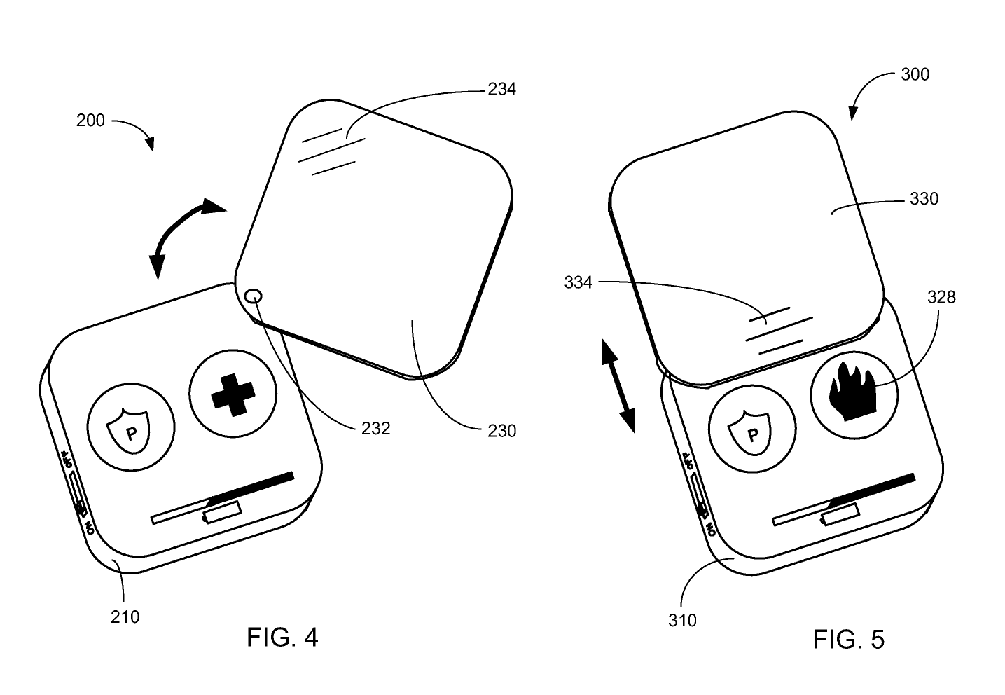

Other embodiments of covers attached to bodies of emergency alert devices are shown in FIGS. 4 and 5. Cover 230 of emergency alert device 200 illustrated in FIG. 4 can swivel away on pin 232 to reveal buttons 120 in body 210. Cover 330 of FIG. 5 can slide against body 310 to reveal buttons 120. Grips 234, 334 can facilitate opening the cover with a single hand, such as by using a thumb while grasping the device with the hand. Of course, many configurations of covers are possible, such as a fabric flap secured by a hook-and-loop fastener, or any other known protection system for a mobile electronic device.

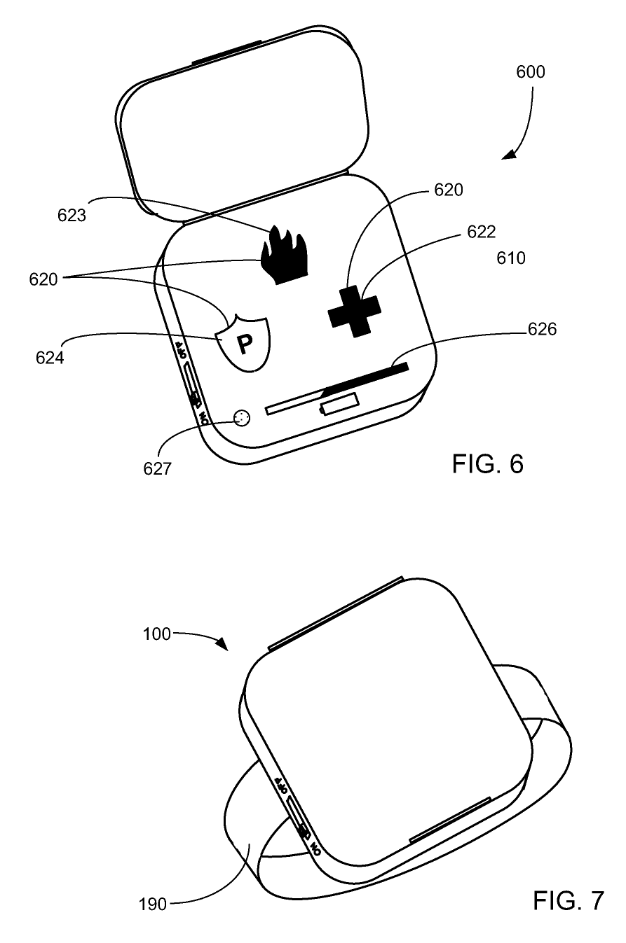

Buttons 120 can be pressed by a user during an emergency to alert emergency response personnel. Buttons 120 can include tactile indicia corresponding to different possible emergency situations such as medical symbol 122 for medical emergencies, or police symbol 124 for law-enforcement emergencies. Other symbols can be used, such as fire symbol 328 (FIGS. 5, 6), for a fire emergency, or a home to contact the user's family, or the indicia may be any other desired symbol. The tactile indicia can be raised or recessed on button 120, or button 120 can be formed in the desired shape, such as buttons 620 shown in FIG. 6. Each shape can be distinct in shape, size, texture, etc. to allow a user to identify the symbol without looking at buttons 120, 620.

In some embodiments, such as is shown in FIG. 8, buttons 420 can be sliders with tactile indicia 422, 424 allowing buttons 420 to be engaged by sliding the indica upwardly, as is shown by indicator 428. The urgency of the emergency can depend on the position of one of buttons 420, as described further below.

Any number of buttons desired can be included. For example, a single button, or more that two buttons may be present. Emergency alert device 600, shown in FIG. 6, includes three buttons 620, including medical emergency 622, fire emergency 623, and police emergency 624. Other embodiments can have four or more buttons, with each of the buttons under the cover. Similarly, one button can be an emergency button, and a second button used to notify family or a friend of a user's current location, without indicating any emergency. In the case of embodiments as shown in FIG. 9 with touch screen 520, different functions can be set to different areas of screen 520, and may be adjusted, or modified as desired.

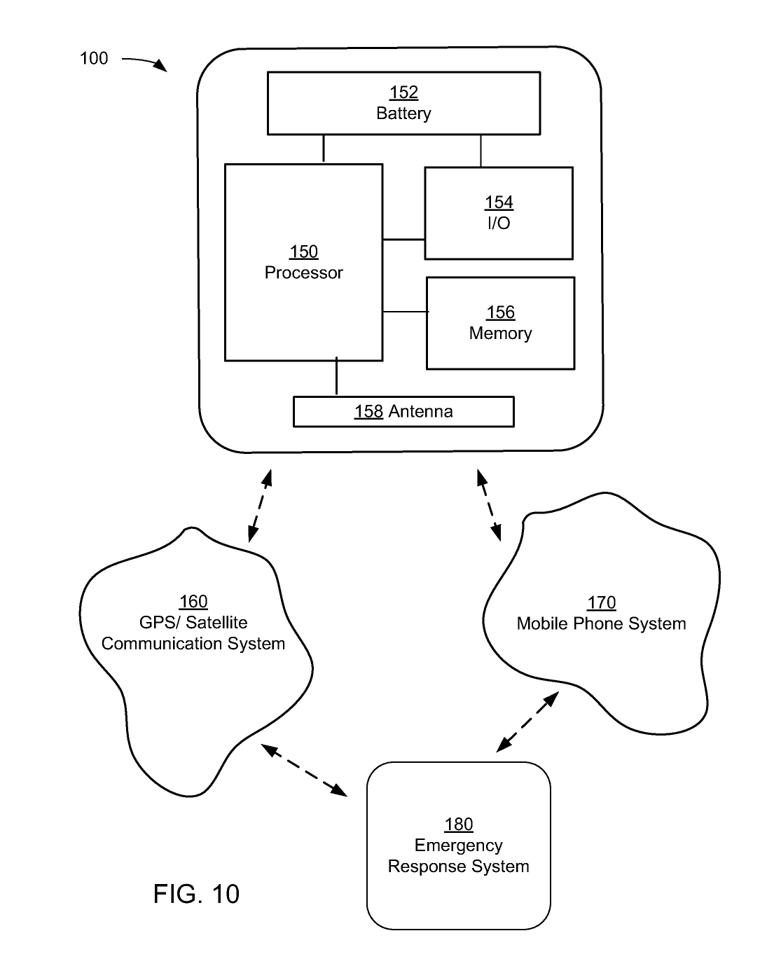

Referring now to FIG. 10, emergency alert device 100 can function using processor 150, along with battery 152, input/output 154, memory 156, and antenna 158. Processor 150 can be any suitable processor or processors to perform the functions described below. Numerous component and programming solutions will be apparent to one of ordinary skill in the art. Battery 152 can be any battery source sufficient to power the device 100. For example, battery 152 can be a rechargeable battery similar to those used in various electronic device and can be recharged through power port 114. Battery 152 can also be a traditional replaceable battery, such as a watch battery, or AAA, AA batteries. Battery 152 can also be recharged using kinetic energy, as is done with some devices.

Input/output 154 refers to, and can include, signal receiving and display, such as from buttons 120, battery display 126, or for touch-screen display 520, as shown in FIG. 8. In some embodiments, other indicators can be included, such as LED 627 (FIG. 6) that lights in a particular pattern or color to indicate that a signal is being sent, that it has been received, the selected urgency of the signal (as described in further detail below), or other similar information. In some embodiments, battery display 126 can be made to perform a similar signaling function.

Antenna 158 can be a GPS antenna, a mobile communications antenna (such as is used in mobile phones, radios, satellite communications, microwave communication devices, etc.), or a combination of antennas for communicating with the various wireless signals and systems available. For example, antenna 158 can receive GPS position information from GPS system 160 periodically and then store recent position information in memory 156 without broadcasting a signal. The position information can be used by emergency personnel to determine the recent movements and current, or recent, positioning of a person using emergency alert device 100. Antenna 158 can then be used to communicate with an available mobile phone system 170 to communicate with emergency response system 180. In some embodiments, other wireless systems can be used for communications with emergency response system 180, such as microwave communications, radio communications, etc.

In some embodiments, communication with emergency response system 180 can be affected through GPS or satellite communications system 160. Similarly, once one of buttons 120 is pushed, antenna 158 can broadcast a GPS location to allow emergency responders to follow and find emergency alert device 100.

When one of buttons 120 is pushed, processor 150 can find an available communications network. The available communications networks can be prioritized for cost or maximum effect. For example, if a mobile phone system is available to dial 911 directly and a GPS or satellite communications system is available, emergency alert device 100 can elect to communicate through the less expensive mobile communications network.

Once a communications link to emergency response system 180 is established, a signal can then be sent to the appropriate emergency response personnel, or a pre-recorded message sent with information regarding the general nature of the emergency. For example, when a user presses button 120 with heath emergency indicia 122, a pre-recorded message can be played for a 911 operator indicating that medical attention is required and including GPS coordinates for emergency alert device 100. Police assistance or a fire emergency can also be conveyed, depending on the button that was pushed. In some embodiments, a system can be provided that takes signals directly and then prompts an operator to communicate the emergency to the appropriate emergency responders.

Emergency alert device 100 can be operated without the need to look at device 100. In some situations, the user can be injured in such a way that a simple button push is possible, but being able to dial a number in a mobile phone is not. Many accidents can render the victim incoherent and unable to use all bodily functions, such as speech, or sight, such as when blood gets into the eyes, making it very difficult to see.

Similarly, some crime victims may not be able to use a mobile phone for fear of increased violence or retaliation. In the case of an abduction or rape, being able to operate emergency alert device 100 with one hand and without needing to look at the device can provide precious minutes of police response time without the perpetrator being aware that the police have been contacted, increasing the potential to apprehend the perpetrator and stop the crime in the act, perhaps before more serious results occur.

Thus, in some embodiments, emergency alert device 100 is silent and discrete, allowing a user to contact emergency responders without having to speak and without the device making any noise. In other embodiments, emergency alert device 100 can include a microphone to allow a 911 operator to hear what is happening, or to allow the user to provide additional information. In some embodiments, emergency alert device can indicate the status of the emergency reporting with a blinking light, or noise of some kind. For example, batter indicator 126 can flash to let the user know that the message has been received by the emergency responders.

In some embodiments, the user can be able to convey the severity of an emergency by pushing buttons 120 multiple times. For example, a user may be able to convey a serious, life-threatening injury by pressing the button four (4) times or a simple injury by pressing it once. Similarly, a user can call for police to investigate a property crime, such as a smashed car window, with a single push, or indicate ongoing threat, such as a rape or kidnapping by pushing the button several times.

Depending on the number of times the button is pushed, a different message can be sent indicating the level of urgency. A single push message can indicate only that an emergency responder is required, whereas several pushes may prompt a message to the 911 operator indicating that a person is critically injured and requires immediate medical attention, or that a crime is in progress, aiding the 911 operator in prioritizing the severity of the call.

In one embodiment, four levels of urgency can be possible, one level per each push within a certain period of time, such as within a minute. Each level would prompt an appropriate message to emergency responders. Any pushes over the maximum number, such as four, may not result in additional urgency being communicated, as the maximum urgency has been achieved. In some cases, pushing the button additional times over the course of several minutes can prompt additional messages that the emergency event is ongoing and requires immediate assistance. Of course, various levels of urgency can be conveyed as desired by one of ordinary skill, from a single level to any practicable number.

In some embodiments, such as is shown in FIG. 7, slider buttons 420 can allow a user to select the urgency of the emergency by the relative position of indicia 422, 424 on the slider buttons 420, where at the bottom indicates no emergency and at the top, the highest level of urgency. Slider buttons 420 can be made such that a person can push the slider buttons 420 to begin the emergency call, with the urgency being based on the height of the button with respect to the indicator 428.

Similarly, if the emergency is resolved, the user can cancel the emergency signals by holding down buttons 120 simultaneously for five or more seconds, prompting a call of all-clear to the emergency responders. This feature may be useful in preventing response when button is accidentally pressed, or when the emergency personnel are no longer required. For example, if a person is being transported to a hospital by a friend, there is no longer a need for an ambulance to respond once the person arrives at the hospital.

In addition to any previously indicated modification, numerous other variations and alternative arrangements may be devised by those skilled in the art without departing from the spirit and scope of this description, and appended claims are intended to cover such modifications and arrangements. Thus, while the information has been described above with particularity and detail in connection with what is presently deemed to be the most practical and preferred aspects, it will be apparent to those of ordinary skill in the art that numerous modifications, including, but not limited to, form, function, manner of operation and use may be made without departing from the principles and concepts set forth herein. Also, as used herein, examples are meant to be illustrative only and should not be construed to be limiting in any manner.

What is claimed is:

1. An emergency alert device for silent communication with a selected emergency service, the emergency alert device comprising:
a case having an interior space for electronic components;
a cover movably coupled to the case;
a battery located within the interior space;
a processor located within the interior space;
an antenna located within the interior space; and
at least one button configured to send a signal to an emergency service, the at least one button having a tactile feature corresponding to the emergency service, the tactile feature enabling a user to identify the emergency service solely by touch.

2. The emergency alert device of claim 1, wherein the case is sized and shaped like a watch.

3. The emergency alert device of claim 1, wherein the cover is configured to cover the at least one button so as to avoid inadvertent pressing of the at least one button.

4. The emergency alert device of claim 1, wherein the emergency service is a police emergency service.

5. The emergency alert device of claim 1, wherein the emergency service is a medical emergency service.

6. The emergency alert device of claim 1, wherein the emergency service is a fire emergency service.

7. The emergency alert device of claim 1, further comprising a battery charge indicator.

8. The emergency alert device of claim 1, wherein the antenna includes at least one of a GPS antenna and a mobile telephone antenna.

9. The emergency alert device of claim 1, further comprising memory operatively coupled to the processor.

10. The emergency alert device of claim 9, wherein the memory is configured to store location data periodically acquired through the GPS antenna.

11. The emergency alert device of claim 10, wherein the signal includes the stored location data.

12. The emergency alert device of claim 9, wherein the signal includes one of a plurality of pre-recorded messages stored on the memory.

13. An emergency alert device for silent communication with a selected emergency service, the emergency alert device comprising:
a case;
an antenna for communicating with an emergency response system;
a button that communicates with an emergency response system when pressed; and
memory having a plurality of pre-recorded messages, each message indicating a level of urgency and type of emergency, the level of urgency corresponding to the number of times the button is pressed.

14. The emergency alert device of claim 13, wherein the button includes a tactile feature, the tactile feature corresponding to the type of emergency.

15. The emergency alert device of claim 13, wherein the antenna is at least one of a GPS antenna and a mobile telephone antenna.

16. The emergency alert device of claim 13, further comprising a cover movably coupled to the case and configured to prevent accidental pressing of the button.

17. The emergency alert device of claim 13, further comprising a status indicator that indicates the level of urgency selected.

18. The emergency alert device of claim 13, wherein the location of the device is communicated to the emergency response system when the button is pressed.

19. The emergency alert device of claim 13, further comprising a second button, wherein each button corresponds to a different type of emergency.

20. The emergency alert device of claim 19, wherein an all-clear message is communicated to the emergency response system when both buttons are pressed simultaneously for at least 5 seconds.
